(19) United States
(12) Patent Application Publication
(10) Pub. No.: US 2009/0241847 A1
(43) Pub. Date: Oct. 1, 2009

(54) MODULAR ANIMAL FEEDER

(76) Inventor: Eddie Staggs,, JR., Heavner, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/410,582

(22) Filed: Mar. 25, 2009

Related U.S. Application Data
(60) Provisional application No. 61/039,262, filed on Mar. 25, 2008.

(51) Int. Cl. A01K 5/01

(52) U.S. Cl. 119/61.1

(57) ABSTRACT

According to the preferred aspect of the instant invention, there is provided an apparatus for feeding livestock that is modular in design. In the preferred embodiment, it consists of alternating support and spanning sections that are preferably held together by one or more steel or similar rods running therethrough. Preferably, the modular components will be made of high density plastic to help reduce the risk of rust and corrosion.

### CROSS-REFERENCE TO RELATED CASES

This application claims the benefit of U.S. provisional patent application Ser. No. 61/039,262, filed on Mar. 25, 2008, and incorporates such provisional application by reference into this disclosure as if fully set out at this point.

### FIELD OF THE INVENTION

This invention relates to the general subject matter of livestock husbandry and in more particular, to an apparatus for feeing cows, horses, pigs, sheep, and the like.

### BACKGROUND OF THE INVENTION

As farmers and ranchers well know, it is generally not a good idea to feed livestock by throwing food out on the ground for them. There are many reasons for this, but among them are that such a practice would inevitably lead to wastage and/or spoilage when the animals stepped on and/or fouled the food given to them to eat. Thus, those who have a need to feed livestock have long understood that it is advantageous to feed them by placing their food in an elevated bin or trough, thereby keeping it off of the ground and making it less subject to spoilage.

Since the problem of how to feed livestock is one that is ancient in origin, it should come as no surprise that ranchers and farmers have had ample opportunity to confront this problem and develop solutions. Indeed, over the years livestock owners have struggled to develop animal feeders that would be suitable to overcome the disadvantages of the prior art. However, and in spite of this, most present day feeding devices are little more than boxes with legs. In most cases, the box is made of metal or concrete, and is placed on legs or otherwise raised to get it off of the ground and out from under foot, thereby making it easier for the animals to reach the food and removing the food from the immediate vicinity of vermin that might be on the ground.

Since these devices are typically constructed of metal or concrete, they are subject to a number of shortcomings. For example, troughs that are made of metal are subject to corrosion/rusting which shortens their lives and in some instances can contaminate food items placed therein. Additionally, troughs made of these concrete or steel are almost invariably heavy and relocating them can prove to be difficult. Further, troughs are usually available in a small number of standard lengths and, if the farmer's or rancher's needs call for something that is longer or shorter than the “standard”, he or she may be required to have their own customized trough built at considerable expense.

Heretofore, as is well known in the animal husbandry arts, there has been a need for a livestock feeding device that does not suffer from the disadvantages of the prior art.

Accordingly, it should now be recognized, as it was recognized by the present inventor, that there exists, and has existed for some time, a very real need for an apparatus for feeding livestock that would address and solve the above-described problem.

Before proceeding to the description of the present invention, however, it should be noted and remembered that the description of the invention that follows, together with the accompanying drawings, should not be construed as limiting the invention to the examples (or the preferred embodiments) shown and described. This is so because those skilled in the art to which the invention pertains will be able devise other forms of this invention within the ambit of the pending claims.

### SUMMARY OF THE INVENTION

According to a first preferred aspect of the instant invention, there is provided a trough-like apparatus for feeding animals which is modular in nature. In the preferred embodiment, the instant invention contains a plurality of discrete alternating spanning and supporting sections, supporting sections being formed with a foot which is intended to be in contact with the ground and spanning sections being supported between two support sections. In the preferred arrangement, the individual sections will be held together using at least one (and preferably three) length(s) of a metal rod such as “all thread” (i.e., a metal rod that is threaded throughout its entire length) which has been inserted through cylindrical apertures that have been provided in each section for that purpose. In some preferred variations, the sections will be formed to be interlocking, in which fewer (or no) metal rods will be necessary.

Preferably, both types of sections will have a generally U-shaped interior and include at least one (but preferably three) cylindrical aperture(s) on their peripheries for receiving a stiffening rod therein.

Additionally, it is expected that a number of these modular sections might be put together to form a trough of a given length which will then preferably be closed on each end by a semicircular plastic plate that is affixed to the trough to prevent the feed from falling out of its ends. In a preferred embodiment, the spanning/support sections will be formed of a high density plastic such as polyethylene.

The foregoing has outlined in broad terms the more important features of the invention disclosed herein so that the detailed description that follows may be more clearly understood, and so that the contribution of the instant inventor to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

Other objects and advantages of the invention will become apparent upon reading the following detailed description and upon reference to the drawings in which:

FIG. 1 illustrates a preferred embodiment of the instant invention.

FIG. 2 contains a schematic illustration of two preferred modular sections of the instant invention.

FIG. 3 contains another preferred embodiment of the instant invention.

FIG. 4 contains another embodiment of the instant invention which utilizes a “snap together” method of assembly.

FIG. 5 illustrates another preferred embodiment of the “snap together” invention.

### DETAILED DESCRIPTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

### PREFERRED EMBODIMENTS

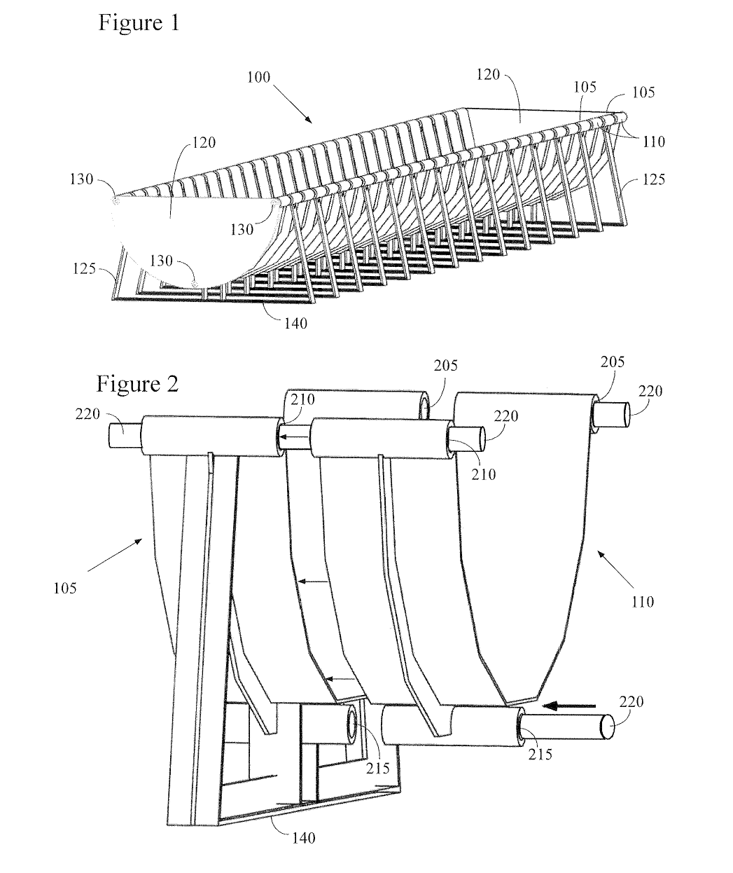

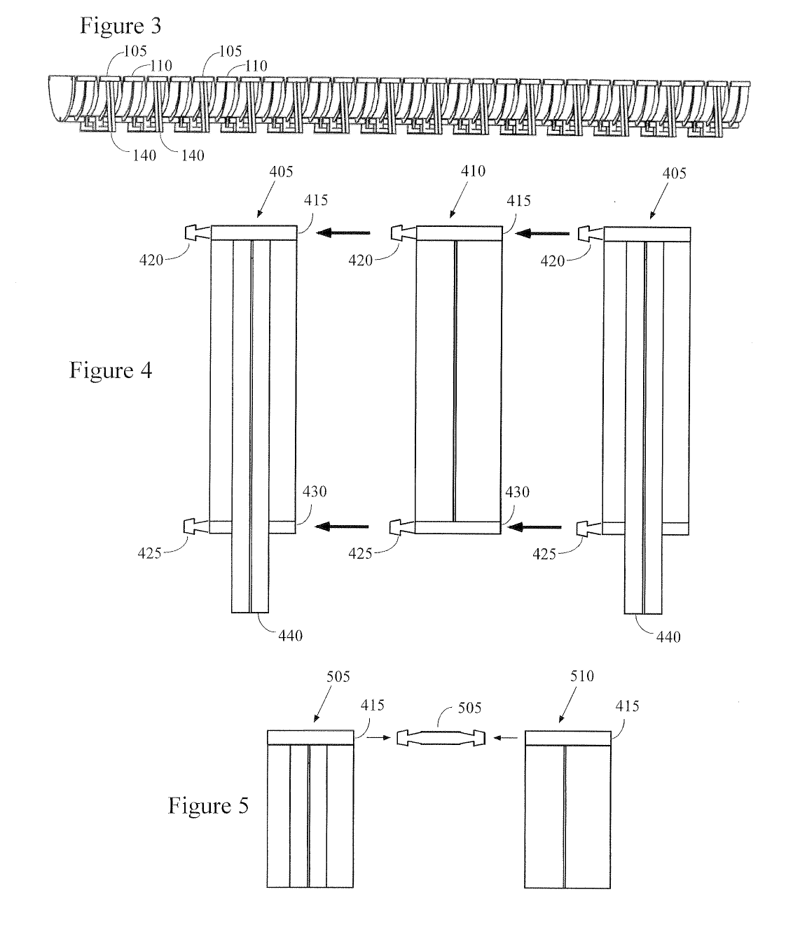

According to a first embodiment of the instant invention and as is generally indicated in FIGS. 1, 2, and 3, there is provided an animal feeder 100 that contains alternating support 105 and spanning 110 modular sections which can be combined arbitrarily to produce various configurations of the instant feeding trough 100. As is generally indicated in FIG. 1, the preferred embodiment utilizes a large number (or as many of the components 105/110 as required to create a trough of the desired length) of sections 105/110 that are closely situated next to each other. The support section 105 will have a foot 140 of some sort which is intended to support that section—and the adjacent spanning section 110 (or sections)—above the ground.

In the preferred embodiment, an all thread rod 220 will be inserted through the passageways 205, 210, and 215 (which are preferably cylindrical), and secured on each end (preferably using a nut and washer combination), with enough tension being applied to hold the instant trough sections together. Preferably, an end member 125 with end plate 120 will be fixed to each end of the trough 100. The end plate 120 has been provided to help keep feed materials that are placed therein from being pushed out of the trough and onto the ground by the animals.

In the preferred embodiment, each of the sections 105 and 110 will be constructed of plastic. Using this sort of material will help ensure that, for the most part, the trough 100 will not be subject to corrosion in the form of rust or subject to attack from chemicals found in the feed (although, it should be clear that any non-plastic component parts that are used might potentially eventually rust). Preferably, each of these sections 105/110 will be comprised of polyethylene or a similar high density plastic which can potentially hold very heavy loads for its weight. That being said, those of ordinary skill in the art will recognize that the material from which the instant invention is constructed is unimportant, so long as the modular structure can be assembled to create a trough. Plastic is preferred because it is not subject to rust and will result in a lighter and (likely) more movable trough 100. Of course, metal (and, preferably, metal that has been treated to be resistant to the weather) or any similar material could be used instead.

In the preferred embodiment of FIG. 2, the cylindrical passageways 205, 210, and 215 will be approximately ¾″ in inner diameter, but those of ordinary skill in the art will recognize that this is a design choice and many other configurations are certainly possible and have been considered by the instant inventor. Additionally, preferably a ⅜″ all thread rod 220 or similar tensioning rod will be inserted through each of the passageways 205, 210, and 215 and secured at each end of the trough using nuts 130 as is generally suggested in FIG. 1. The instant inventor has determined that inserting a metal rod 220 such as all thread into the passageways 205, 210, and 215 provided for by the instant invention tends to stiffen the trough 100, and especially so when the nuts 130 (or other fasteners) on the end of the trough are tightened, thereby compressing the different elements of the trough 100 together and forming a convex interior suitable for storing animal food.

Note that in FIG. 2 the rod 220 is not shown passing through all of the passageways 205, 210, and 215, although in practice it would necessarily be threaded through each of the trough 100 elements. That was done in FIG. 2 in order to make clearer the structure of this embodiment. However, it should be noted that it is preferred passageways 205, 210, and 215 be cylindrical (or otherwise shaped, preferably to match the cross section of the tensioning rod 220) and be axially aligned so that one or more tensioning rods 220 may be threaded through all such aligned passageways and be secured at opposite ends to provide the compressive force necessary to hold the trough 100 components together.

In the preferred embodiment, after they are tightened the nuts 130 on each end of the tensioning rod 220 will then act to apply compression to the trough 100, thereby helping it hold together and forming a substantially continuous feeder interior.

In one preferred embodiment, each support section 105 section will be about 4″ in width, about 11″ high and 16″ across. Of course, those of ordinary skill in the art to which this application pertains will immediately recognize that the precise dimensions that are utilized in practicing the instant invention are a design choice that will likely need to be modified to suit the particular application. Further, although in the preferred embodiment the support 105 and spanning 110 sections will be approximately the same width, this is obviously not required and one could certainly be much wider or narrower than the other.

In another preferred embodiment, the spanning and support sections will be designed to “snap” together, rather than utilizing one or more elongated metal rods. As is indicated in the end-on view of FIG. 4, in one preferred arrangement each of the modular sections 405/410 will include an upper locking insert 420 and a matching upper cavity 415, the intent being that support sections 405 (each with foot element 440) and spanning sections 410 can be quickly snapped together to create a trough on site. Note that in the embodiment of FIG. 4 each modular section 405/410 actually has two upper locking inserts 420 and two upper cavities 415, the second of which not being visible in this view. In some preferred arrangements, there will additionally be one or more lower locking inserts 425 and matching cavities 430. However, it is certainly possible that the embodiment of FIG. 4 could be constructed using some combination of tensioning metal rods (e.g., all thread) and locking inserts (420, 425) and cavities (415, 430). For example, the lower inserts 425/cavities 430 could be replaced by an all thread rod that runs the length of the trough. Thus, for purposes of the instant disclosure, when the term “tensioning member” is used, that term should be broadly construed to include instances where the rod is a single metal (or other) rod that extends the entire length of the trough and instances where the tensioning member comprises a plurality of inserts. However, in either case the rod or inserts must run substantially the entire length of the trough.

FIG. 5 contains another preferred embodiment of the “snap together” invention, which utilizes a separate insert 515 that is designed to mate on each end with the corresponding modular sections 505 and 510. Note that this embodiment is substantially similar to the embodiment of FIG. 4, except that locking insert 420 is not integral to either of the modular elements 405/410. Note, of course, that some combination of locking inserts 420 and tensioning rods 220 might be used.

Note that in the preferred embodiment the spanning sections (110 and 410) are so-called because they are not in direct contact with the ground but are instead suspended between two support sections. However, the instant inventor has determined that in some instances (e.g., where additional load capacity is desired) it might be advantageous to add a smaller supporting foot (or post, column, etc.) to the spanning sections, thereby placing that section also in contact with the ground and providing additional support.

Additionally, although the preferred embodiment as described and illustrated herein shows support sections alternating with spanning sections, that arrangement is not strictly necessary. For example, depending on the application, the instant modular trough 100 might consist exclusively of support sections 105, such an arrangement obviously resulting in a trough 100 that would be able to carry heaver loads. Of course, it might be anticipated that this variation would be more expensive to manufacture if for no other reason than the additional raw material (e.g., plastic) that would be required. In other arrangements, it is certainly possible that one support section might be separated from the next by multiple spanning sections 110, although that would not usually be preferred unless the intervening spanning sections had their own support foot as has been discussed previously. However, if the spanning sections 110 were made to be narrower than the support sections 105 and/or a minimal load is anticipated, it is certainly possible that an arrangement of this sort could be used.

With respect to the end members 125, in the preferred embodiment they will also be support members (i.e., contain weight bearing legs that are intended to be in contact with the ground). However, at minimum the end members would be expected to include some sort of end panel 120 or other barrier to close it so that the contents of the trough are kept in place. Obviously, one or more so-called “end members” could also be added to the interior of the trough for purposes of compartmentalizing its contents.

Still further, it should be noted that although it is preferred (for any number of reasons) that the trough have a U-shaped cross section, that is merely a preference and not a requirement. That being said, trough cross sections that are not U-shaped or otherwise smoothly curved will tend to have internal corners or vertices that will likely accumulate debris and, as a consequence, a smoothly concave trough cross section is preferred.

Still further, it is preferred that the tensioning rod 220 (and associated passageways) be circular in cross section but, of course, that is a design choice that will be left up to the manufacture. However, it is important that the tensioning member 220 be able to fit through the passageways so as to impart rigidity to the invention.

Finally, it should be noted that the instant invention is suitable for use with any kind of livestock including, without limitation, cattle, sheep, horses, pigs, llamas, etc.

While the inventive device has been described and illustrated herein by reference to certain preferred embodiments in relation to the drawings attached hereto, various changes and further modifications, apart from those shown or suggested herein, may be made therein by those skilled in the art, without departing from the spirit of the inventive concept, the scope of which is to be determined by the following claims

What is claimed is:

1. A modular animal feeder, comprising:
(a) a first end section, said first end section having at least one aperture therethrough;
(b) at least one support section, each of said at least one support section
(b1) having a substantially concave upper surface,
(b2) having at least one aperture therethrough, said at least one aperture being positionable to be in substantial alignment with said at least one aperture of said first end section, and,
(b3) having at least one foot which is positionable to be in contact with the ground;
(c) a second end section, said second end section having at least one aperture therethrough,
(c1) said at least one aperture of said second end section being positionable to be in alignment with said aperture of each of said at least one support section and with said first end section, and,
(c2) each of said at least one support section and said first and second end sections all being in substantially linear alignment, with each of said at least one support section being positioned between said first and second end section; and,
(d) at least one tensioning member, each of said at least one tensioning member passing through said at least one aperture of said first end section, said at least one aperture of said second end, and each of said at least one aperture of said at least one support section, said tensioning member urging together said first end section, each of said at least one support section, and said second end section to create a substantially continuous concave cavity suitable for holding animal feed therein.

2. The modular animal feeder according to claim 1, wherein said first end section and said section end sections each have at least one foot which is positionable to be in contact with the ground.

3. The modular animal feeder according to claim 1, further comprising:
(e) at least one spanning member, each of said at least one spanning member having at least one aperture therethrough,
(e1) each of said at least one spanning member having a substantially concave upper surface,
(e1) said at least one spanning member aperture being positionable to be in substantial linear alignment with said at least one aperture of said first end section and said at least one aperture of said second end.

4. The modular animal feeder according to claim 1, wherein said first end section aperture, said second end section aperture, and each of said at least one support section aperture are all cylindrical apertures.

5. The modular animal feeder according to claim 4, wherein each of said at least one tensioning member is a substantially cylindrical metal rod.

6. The modular animal feeder according to claim 5, wherein each of said tensioning member is an all thread rod.

7. The modular animal feeder according to claim 6,
wherein each of said at least one tensioning member has a first end and a second end,
wherein each of said at least one tensioning member first end is secured to said first end section by a first nut and first washer, and
wherein each of said at least one tensioning member second end is secured to said second end section by a second nut and a second washer.

8. The modular animal feeder according to claim 7, wherein each of said tensioning member has a first end and a second end, wherein said first end of each of said tensioning member extends through said first end member and wherein said second end of each of said tensioning member extends through said second end member, and wherein each of said tensioning member first end is secured with a first nut and a first washer, and wherein each of said tensioning member second end is secured with a second nut and a second washer.

9. The modular animal feeder according to claim 1,
wherein said first end section has three apertures therethrough,
wherein said second end section has three apertures therethrough,
wherein each of said support sections has three apertures therethrough, and,
wherein there are three tensioning members, each of said three tensioning members passing through a different one of said three first end section apertures, a different one of said three second end section apertures, and a different one of each of said at least one support section apertures,
said three tensioning members cooperating to urge together said first end section, each of said at least one support section, and said second end section to create a substantially continuous concave cavity suitable for holding animal feed therein.

10. A modular animal feeder, comprising:
(a) a first end section, said first end section having at least one aperture therethrough;
(b) at least one spanning section, each of said at least one spanning section
(b1) having a substantially concave upper surface, and,
(b2) having at least one aperture therethrough, said at least one aperture being positionable to be in substantial alignment with said at least one aperture of said first end section;
(c) a second end section, said second end section having at least one aperture therethrough,
(c1) said at least one aperture of said second end section being positionable to be in alignment with said aperture of each of said at least one support section and with said first end section, and
(c2) each of said at least one spanning section and said first and second end sections all being in substantially linear alignment, with each of said at least one support section being positioned between said first and second end section; and,
(d) at least one tensioning member, each of said at least one tensioning member passing through said at least one aperture of said first end section, said at least one aperture of said second end, and each of said at least one aperture of said at least one spanning section, said tensioning member urging together said first end section, each of said at least one spanning section, and said second end section to create a substantially continuous concave cavity suitable for holding animal feed therein.

11. The modular animal feeder according to claim 10, wherein said first end section and said section end sections each have at least one foot which is positionable to be in contact with the ground.

12. The modular animal feeder according to claim 10, wherein said first end section aperture, said second end section aperture, and each of said at least one spanning section aperture are all cylindrical apertures.

13. The modular animal feeder according to claim 12, wherein each of said at least one tensioning member is a substantially cylindrical metal rod.

14. The modular animal feeder according to claim 13, wherein each of said tensioning member is an all thread rod.

15. The modular animal feeder according to claim 14, wherein each of said tensioning member has a first end and a second end, wherein said first end of each of said tensioning member extends through said first end member and wherein said second end of each of said tensioning member extends through said second end member, and wherein each of said tensioning member first end is secured with a first nut and a first washer, and wherein each of said tensioning member second end is secured with a second nut and a second washer.

16. The modular animal feeder according to claim 10,
wherein said first end section has three apertures therethrough,
wherein said second end section has three apertures therethrough,
wherein each of said support sections has three apertures therethrough, and,
wherein there are three tensioning members, each of said three tensioning members passing through a different one of said three first end section apertures, a different one of said three second end section apertures, and a different one of each of said at least one support section apertures,
said three tensioning members cooperating to urge together said first end section, each of said at least one support section, and said second end section to create a substantially continuous concave cavity suitable for holding animal feed therein.

17. The modular animal feeder according to claim 10, wherein at least one of said at least one spanning member has a foot that is positionable to be in contact with the ground.
